(19) United States
(12) Patent Application Publication
(10) Pub. No.: US 2008/0068603 A1
(43) Pub. Date: Mar. 20, 2008

(54) ANTI-VIBRATION APPARATUS, EXPOSURE APPARATUS, AND DEVICE MANUFACTURING METHOD

(75) Inventors: Ryo Nawata, Utsunomiya-shi (JP); Mitsuru Inoue, Utsunomiya-shi (JP); Hiroshi Ito, Utsunomiya-shi (JP); Makoto Mizuno, Utsunomiya-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/846,904

(22) Filed: Aug. 29, 2007

(30) Foreign Application Priority Data
Sep. 14, 2006 (JP) 2006-249957

(51) Int. Cl. G01N 21/01; G03B 27/62; H01S 4/00

(52) U.S. Cl. 356/244; 29/592.1; 355/75

(57) ABSTRACT

An anti-vibration apparatus includes a target object, a reference object, a measuring device which measures the position of the target object relative to the reference object, a driving mechanism to drive the target object based on the measurement result obtained by the measuring device, a Lorentz's force actuator which supports the reference object, and a power supply device which supplies a constant current to the Lorentz's force actuator. The actuator which supports the reference object uses a Lorentz's force actuator or an actuator which supports the reference object by the pressure of a gas.

### BACKGROUND OF THE INVENTION

1. Field of the Invention

The present invention relates to an anti-vibration apparatus, exposure apparatus, and device manufacturing method.

2. Description of the Related Art

Conventionally, a process of manufacturing a semiconductor element formed from the micropattern of, for example, an LSI or VLSI adopts a reduction projection exposure apparatus which reduces a pattern formed on an original such as a reticle and projects and transfers it onto a substrate coated with a photosensitive material. As the degree of integration of semiconductor elements increases, further micropatterning becomes necessary. The exposure apparatus has coped with micropatterning along with the development of the resist process.

To improve the resolving power of the exposure apparatus, there are available a method of shortening the wavelength of exposure light and a method of increasing the numerical aperture (NA) of a projection optical system. The resolving power is generally known to be proportional to the wavelength of exposure light and inversely proportional to the NA.

While these measures for micropatterning are taken, attempts to further improve the throughput of the exposure apparatus are being made from the viewpoint of the manufacturing cost of semiconductor elements. Examples are to shorten the exposure time per shot by increasing the output of an exposure light source and to increase the number of elements per shot by increasing the exposure area.

Unfortunately, the exposure apparatus aiming at micropattern exposure suffers degradation in overlay accuracy and exposure image accuracy due to vibration conducted from the installation floor. If exposure is performed after such vibration settles down, the throughput decreases. To prevent this problem, the conventional exposure apparatus adopts a method of supporting the main body portion by an anti-vibration apparatus to reduce the influence of floor vibration.

The conventional anti-vibration apparatus uses a gas spring inserted between the anti-vibration surface and the floor. In addition, to increase the dampening characteristic of the anti-vibration apparatus, a velocity feedback control system is formed using an acceleration sensor arranged on the anti-vibration surface and an actuator interposed between the anti-vibration surface and the floor. However, the natural frequency of the anti-vibration apparatus is determined by that of the gas spring. For this reason, even when the velocity feedback control system is formed to increase the dampening characteristic of the anti-vibration apparatus, it has a natural frequency of about 3 to 5 Hz at the lowest. To remove vibration components up to lower frequencies, it is necessary to further decrease the natural frequency of the anti-vibration apparatus.

Japanese Patent Laid-Open No. 2005-294790 discloses an anti-vibration apparatus which feedback-controls the position of the anti-vibration surface with respect to a reference object supported by a support spring having a natural frequency lower than that of a gas spring so that the natural frequency of the anti-vibration apparatus becomes lower than that of the gas spring.

The anti-vibration apparatus disclosed in Japanese Patent Laid-Open No. 2005-294790 feedback-controls the position of the anti-vibration surface with respect to the reference object supported by the support spring. This makes it impossible to decrease the natural frequency of the anti-vibration apparatus to be equal to or lower than that of the support spring (about 0.5 Hz). To meet a demand for further micropatterning of semiconductor elements in the future, it is necessary to remove, especially, low-frequency components which cause image shifts, of floor vibration components which adversely affect the exposure performance.

### SUMMARY OF THE INVENTION

It is an object of the present invention to provide an anti-vibration apparatus improved in low-frequency component removal performance, which is free from any natural frequency in principle.

According to one aspect of the present invention, there is provided an anti-vibration apparatus including a target object, a reference object, a measuring device which measures a position of the target object relative to the reference object, a driving mechanism to drive the target object based on the measurement result obtained by the measuring device, a Lorentz's force actuator which supports the reference object, and a power supply device which supplies a constant current to the Lorentz's force actuator.

According to another aspect of the present invention, there is provided an anti-vibration apparatus including a target object, a reference object, a measuring device which measures a position of the target object relative to the reference object, a driving mechanism to drive the target object based on the measurement result obtained by the measuring device, and an actuator which supports the reference object by a pressure of a gas, wherein the actuator is controlled to support the reference object by a constant pressure.

According to the present invention, it is possible to provide an anti-vibration apparatus excellent in low-frequency component removal performance, which is free from any natural frequency in principle.

Further features of the present invention will become apparent from the following description of exemplary embodiments with reference to the attached drawings.

### BRIEF DESCRIPTION OF THE DRAWINGS

FIG. 1 shows an embodiment in which a Lorentz's force actuator supports a reference object from a floor;

FIG. 2 shows an embodiment in which a Lorentz's force actuator supports a reference object from a surface plate;

FIG. 3 shows an embodiment in which six Lorentz's force actuators support a reference object;

FIG. 4 shows an embodiment in which the degrees of freedom of a reference object around the X-, Y-, and Z-axes are constrained using guides;

FIG. 5 shows a reference object whose degrees of freedom around the Z-, X-, and Y-axes are constrained using guides;

FIG. 6 shows an embodiment in which the degrees of freedom of a reference object around the X-, Y-, and Z-axes are constrained using a position feedback control system;

FIG. 7 shows an embodiment in which a reference object is supported by the gas pressure;

FIG. 8 shows an embodiment in which a Lorentz's force actuator uses a velocity feedback control system;

FIG. 9 shows an embodiment in which a target object is a lens barrel supporting member of an exposure apparatus;

FIG. 10 shows the difference in performance between anti-vibration apparatuses according to a prior art and the present invention;

FIG. 11 is a flowchart for explaining device manufacture using an exposure apparatus; and

FIG. 12 is a flowchart illustrating details of the wafer process in step S4 of the flowchart shown in FIG. 11.

### DESCRIPTION OF THE EMBODIMENTS

Embodiments of the present invention will be described below with reference to the accompanying drawings.

### First Embodiment

In the first embodiment, a Lorentz's force actuator 23 is used to support a reference object 21 by a constant force. The position of a surface plate 2 is feedback-controlled with respect to the reference object 21 supported by the constant force. An anti-vibration apparatus excellent in low-frequency component removal performance is thus provided. In the first embodiment, a target object is the surface plate 2.

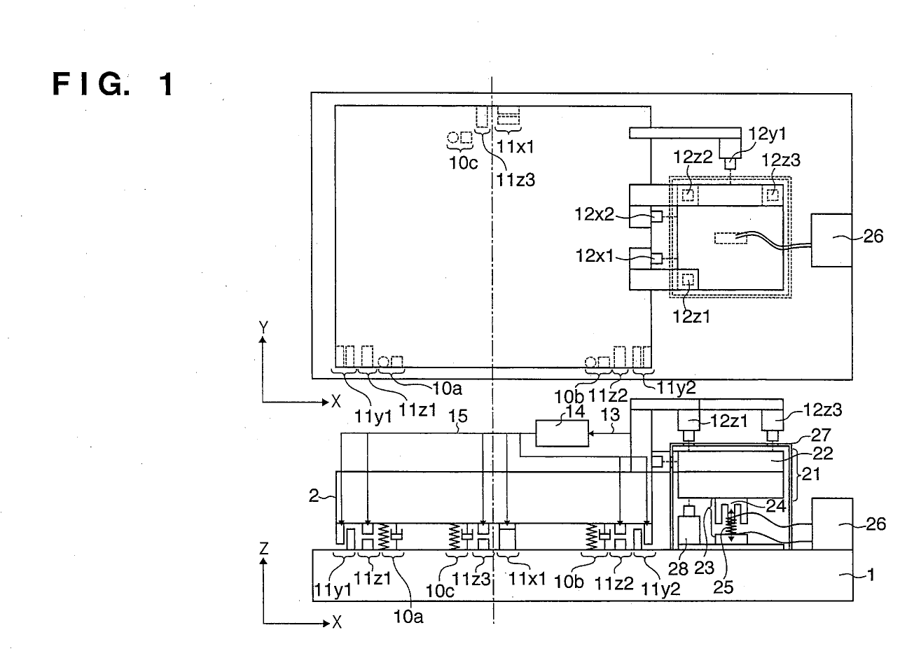

An anti-vibration table will be explained first. The anti-vibration table is formed by causing passive dampers 10a to 10c including, for example, gas springs to support the surface plate 2 from a floor 1. FIG. 1 shows only springs and dashpots of the passive dampers 10a to 10c in the Z-axis direction. However, the passive dampers 10a to 10c have rigidity and damping ratio in the X- and Y-axis directions as well.

Z actuators 11z1 to 11z3, X actuator 11x1, and Y actuators 11y1 and 11y2 are interposed between the surface plate 2 and the floor 1. The Z actuators 11z1 to 11z3 each generate a driving force in the Z-axis direction. The X actuator 11x1 generates a driving force in the X-axis direction. The Y actuators 11y1 and 11y2 each generate a driving force in the Y-axis direction. The actuator 11 uses a linear motor here. The above-described six actuators 11 can drive the surface plate 2 in the six axis-directions.

The reference object 21 is supported by a constant force output from the Lorentz's force actuator 23. The Lorentz's force actuator can use, for example, a linear motor or voice coil motor.

As shown in FIG. 1, the Lorentz's force actuator 23 is formed by a yoke 24 and coreless coil 25. The yoke 24 includes a magnet. Supplying a current to the coreless coil 25 passing through the magnetic field of the yoke 24 generates a Lorentz's force. Supplying a constant current to the coreless coil 25 allows the Lorentz's force actuator 23 to generate a constant force. The constant force generated by the Lorentz's force actuator 23 is balanced gravitational force acting on the reference object 21. With this operation, the reference object 21 completely floats in the air and hence becomes free from the influence of any displacement due to floor vibration.

The coreless coil 25 connects to a power supply device 26. The power supply device 26 incorporates a current minor loop for supplying a constant current to the coreless coil 25. Adjusting the gain of the current minor loop makes it possible to adjust a counter electromotive force generated by the Lorentz's force actuator 23. A larger counter electromotive force produces a greater effect of damping vibration acting on the reference object 21. However, an excessively large counter electromotive force makes the reference object 21 susceptible to the velocity of the floor 1 if it occurs.

To improve the disturbance characteristic of the reference object, it suffices to insert an integrator in the current minor loop.

As shown in FIG. 1, a measuring mirror 22 is attached to the reference object 21. A non-contact measuring device 12 attached to the surface plate 2 measures the measuring mirror 22 on the reference object 21 to be able to measure a relative displacement between the surface plate 2 and the reference object 21. The non-contact measuring device 12 uses a laser interferometer here.

Non-contact measuring devices 12x1 and 12x2 can measure a relative displacement between the surface plate 2 and the reference object 21 in the X-axis direction and their relative angle around the Z-axis. A non-contact measuring device 12y1 can measure a relative displacement between the surface plate 2 and the reference object 21 in the Y-axis direction. Non-contact measuring devices 12z1, 12z2, and 12z3 can measure a relative displacement between the surface plate 2 and the reference object 21 in the Z-axis direction and their relative angles around the X- and Y-axes. The above-described six non-contact measuring devices 12 can measure the relative position between the reference object 21 and the surface plate 2 in the six axis-directions.

A compensator 14 converts measurement information 13 obtained by the non-contact measuring device 12 into a command value to be input to the actuator 11. The compensator 14 includes, for example, a decoupled matrix, PID compensator, and output distribution matrix.

As described above, it is possible to feedback-control the position of the surface plate 2 with respect to the reference object 21. Since the reference object 21 completely floats in the air and hence becomes free from the influence of any displacement due to floor vibration, the surface plate 2 the position of which is feedback-controlled with respect to the reference object 21 also becomes free from the influence of any displacement due to vibration of the floor 1. The velocity of the surface plate 2 may be feedback-controlled with respect to the reference object 21.

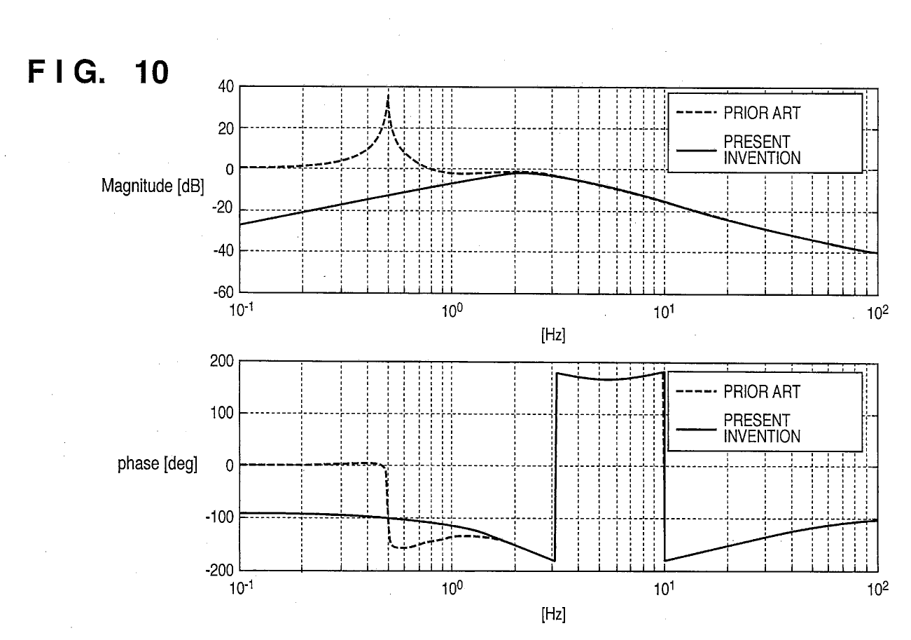

FIG. 10 shows the difference in performance between anti-vibration apparatuses according to a prior art and the present invention. FIG. 10 illustrates the transmission characteristic from the floor to the surface plate. FIG. 10 reveals that the anti-vibration apparatus according to the prior art removes vibration components at a frequency up to about 2 Hz at the lowest. Still worse, the anti-vibration apparatus resonates at the natural frequency of the support spring (0.5 Hz or its neighborhood) supporting the reference object.

The anti-vibration apparatus according to the present invention removes vibration components up to a frequency as low as 2 Hz or less. In addition, since a support spring for supporting the reference object is used unlike the prior art, the anti-vibration does not resonate at its natural frequency.

The reference object 21 floats in the air upon receiving a constant force that balances its gravitational force from the Lorentz's force actuator 23. For this reason, a variation in atmospheric pressure acts to move the reference object 21. Furthermore, when the magnetic field acts on the Lorentz's force actuator 23, a force generated by it does not balance the gravitational force of the reference object 21 any longer. This results in the movement of the reference object 21. To prevent these problems, as shown in FIG. 1, the reference object 21 and Lorentz's force actuator 23 may be covered with a seal member 27.

As the Lorentz's force actuator 23 generates a force that balances the gravitational force of the reference object 21 and it floats in the air, it is displaced in a direction opposite to that of rotation of the earth upon receiving a Coriolis force. The reference object 21 is likely to move upon receiving a force due to some kind of external factor, in addition to the Coriolis force. It is therefore necessary to correct the position of the reference object 21 periodically or occasionally. As shown in FIG. 1, a sensor 28 for position correction (a third measuring device for measuring the position of the reference object) may be separately provided.

### Second Embodiment

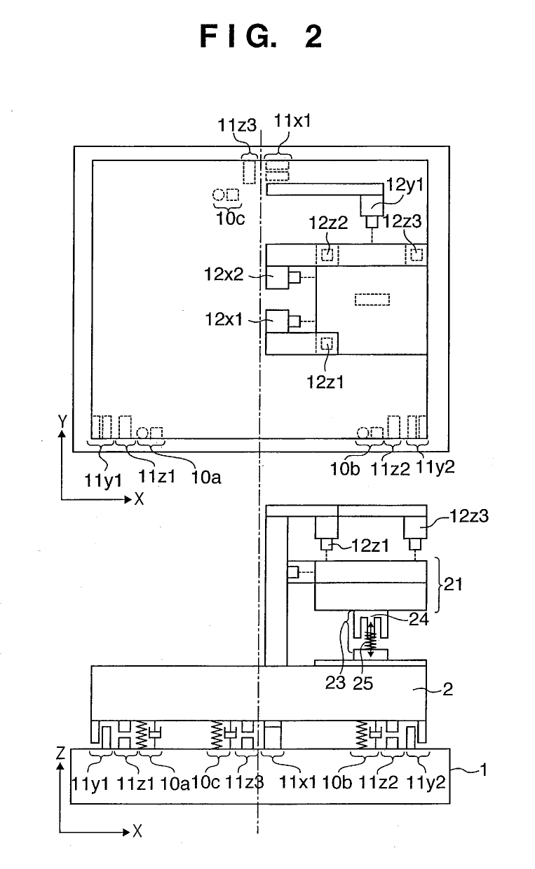

As shown in FIG. 2, the first and second embodiments are different in whether a Lorentz's force actuator 23 is attached to a floor 1 or surface plate 2. The characteristic feature of the present invention is that the Lorentz's force actuator 23 supports a reference object 21 by a constant force. Accordingly, the Lorentz's force actuator 23 may be attached to the floor 1, surface plate 2, or another member. In the second embodiment, the Lorentz's force actuator 23 is provided on the surface plate 2 on a substrate stage.

As in the first embodiment, a non-contact measuring device 12 measures the position of the reference object 21 to be able to measure a displacement of the surface plate 2 relative to the reference object 21. Feedback-controlling the position of the surface plate 2 based on the measured relative displacement allows it to be free from the influence of any displacement due to vibration of the floor. The velocity of the surface plate 2 may be feedback-controlled with respect to the reference object 21. Also according to the second embodiment, it is possible to provide an anti-vibration apparatus excellent in low-frequency component removal performance, which is free from any natural frequency in principle.

### Third Embodiment

In the third embodiment, a reference object 21 is supported using six Lorentz's force actuators. Lorentz's force actuators 23x1 and 23x2 generate forces to drive the reference object 21 in the X-axis direction and around the Z-axis. A Lorentz's force actuator 23y1 generates a force to drive the reference object 21 in the Y-axis direction. Lorentz's force actuators 23z1, 23z2, and 23z3 generate forces to drive the reference object 21 in the Z-axis direction.

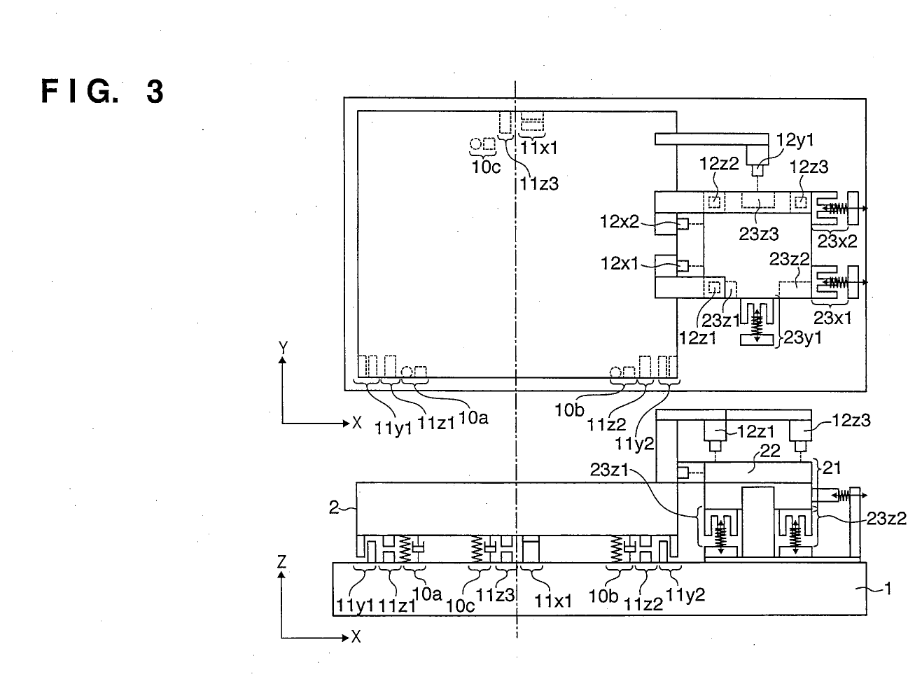

The Lorentz's force actuator has a property of generating forces in directions other than an intended driving direction. In view of this, as shown in FIG. 3, the Lorentz's force actuators are so arranged as to drive the reference object 21 in the six axis-directions. With this arrangement, each Lorentz's force actuator can cancel any forces in directions other than an intended driving direction, which are generated by the other Lorentz's force actuators. This makes it possible to apply, to the reference object 21, only a force that balances gravitational force. The Lorentz's force actuators 23x1 and 23x2, 23y2, and 23z1 to 23z3 each can support the reference object 21 by a constant position independent force.

A non-contact measuring device 12 measures the reference object 21 to be able to calculate a displacement of a surface plate 2 relative to the reference object 21. Feedback-controlling the position of the surface plate 2 based on the measured relative displacement allows it to be free from the influence of any displacement due to vibration of the floor. The velocity of the surface plate 2 may be feedback-controlled with respect to the reference object 21.

It is therefore possible to provide an anti-vibration apparatus excellent in low-frequency component removal performance, which is free from any natural frequency in principle. Although the six-Lorentz's force actuators are used in the third embodiment, the number of Lorentz's force actuators is not limited to six.

### Fourth Embodiment

In the fourth embodiment, the Lorentz's force actuators 23x1, 23x2, and 23y1 according to the third embodiment are omitted. Instead, guides 30x1, 30x2, 30y1, and 30y2 are provided to constrain the movement of a reference object 21a in the X- and Y-axis directions and around the Z-axis.

Lorentz's force actuators 23z1, 23z2, and 23z3 support the reference object 21a by constant position independent forces regarding the Z-axis direction and around the X- and Y-axes. This makes it possible to use the reference object 21a as the measurement reference of a position feedback control system for a surface plate 2.

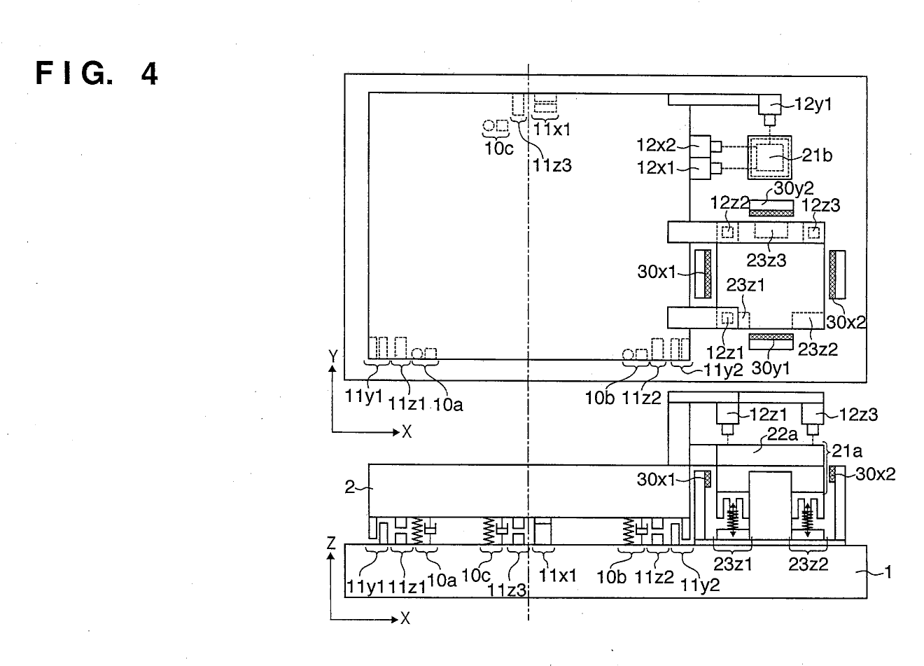

However, the use of the guides 30x1, 30x2, 30y1, and 30y2 makes the reference object 21a exhibit springness in the X- and Y-axis directions and around the Z-axis. For this reason, it is impossible to use the reference object 21a as the measurement reference of the position feedback control system for the surface plate 2 in the X- and Y-axis directions and around the Z-axis. In view of this, as shown in FIG. 4, a reference object 21b is used as a measurement reference for feedback-controlling the position of the surface plate 2 in the X- and Y-axis directions and around the Z-axis.

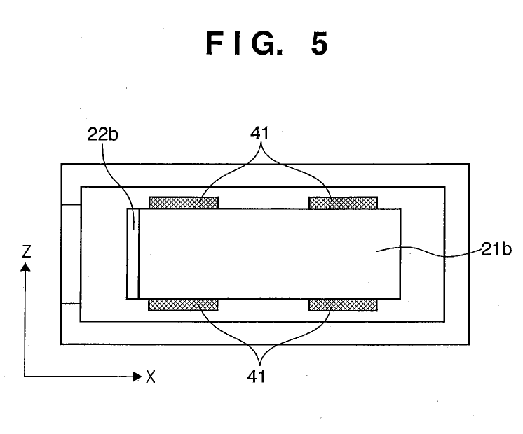

As shown in FIG. 5, guides 41 such as air guides or electromagnetic guides constrain the movement of the reference object 21b in the Z-axis direction and around the X- and Y-axes. In contrast, in the X- and Y-axis directions and around the Z-axis, the reference object 21b does not receive any position dependent forces.

It is therefore possible to use the reference object 21a as a measurement reference in the Z-axis direction and around the X- and Y-axes. Using the reference object 21b as a measurement reference in the X- and Y-axis directions and around the Z-axis makes it possible to provide measurement references free from any position dependent forces in the six axis-directions.

Measuring the reference object 21a using non-contact measuring devices 12z1, 12z2, and 12z3 makes it possible to measure a displacement of the surface plate 2 relative to the reference object 21a in the Z-axis direction and their relative angles around the X- and Y-axes. The reference object 21b is measured using non-contact measuring devices 12x1, 12x2, and 12y1 as well. This makes it possible to measure a displacement of the surface plate 2 relative to the reference object 21b in the X- and Y-axis directions and their relative angle around the Z-axis.

Feedback-controlling the position of the surface plate 2 based on the measured relative displacement and relative angle allows it to be free from the influence of any displacement due to vibration of the floor. The velocity of the surface plate 2 may be feedback-controlled with respect to the reference object 21.

As described above, it is possible to provide an anti-vibration apparatus excellent in low-frequency component removal performance, which is free from any natural frequency in principle.

### Fifth Embodiment

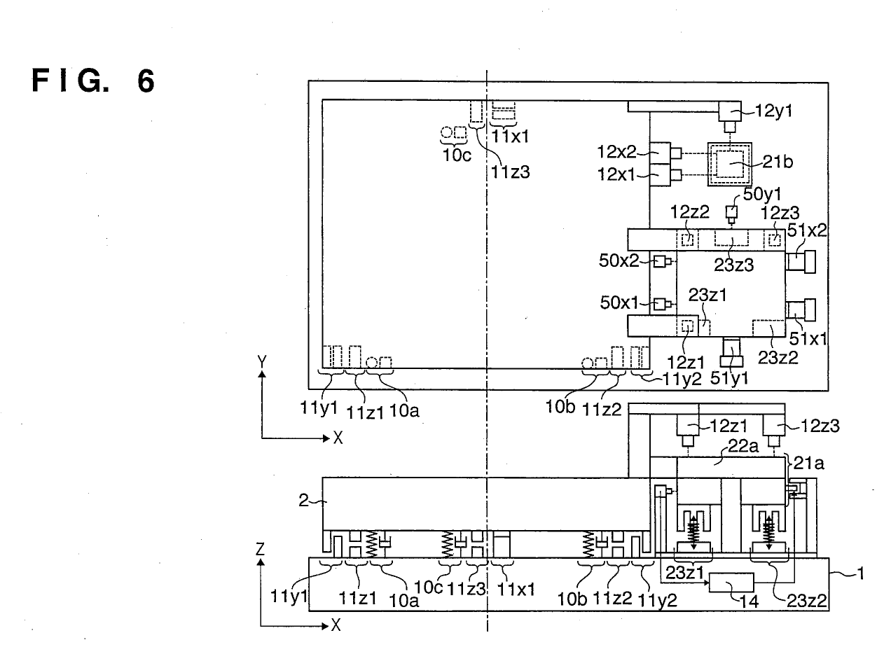

As shown in FIG. 6, in the fifth embodiment, position feedback control is performed using a non-contact measuring device 50 and actuator 51 instead of constraining the movement of the reference object 21a according to the fourth embodiment in the X- and Y-axis directions and around the Z-axis using the guides. A position feedback control system for a reference object 21a will be explained below.

Non-contact measuring devices 50x1 and 50x2 can measure a displacement of the reference object 21a in the X-axis direction and its rotation angle around the Z-axis, while a non-contact measuring device 50y1 can measure a displacement of the reference object 21a in the Y-axis direction. Actuators 51x1 and 51x2 can drive the reference object 21a in the X-axis direction and around the Z-axis, while an actuator 51y1 can drive the reference object 21a in the Y-axis direction. The actuators 51x1, 51x2, and 51y1 are driven based on the pieces of measurement information obtained by the non-contact measuring devices 50x1, 50x2, and 50y1. This makes it possible to feedback-control the position of the reference object 21a in the X- and Y-axis directions and around the Z-axis.

Lorentz's force actuators 23z1, 23z2, and 23z3 support the reference object 21a by constant position independent forces regarding the Z-axis direction and around the X- and Y-axes. This makes it possible to use the reference object 21a as the measurement reference of the position feedback control system for a surface plate 2.

However, the non-contact measuring device 50 and actuator 51 feedback-control the position of the reference object 21a. For this reason, it is impossible to use the reference object 21a as the measurement reference of the position feedback control system for the surface plate 2 in the X- and Y-axis directions and around the Z-axis.

As in the fourth embodiment, it suffices to use a reference object 21b as the second reference object. That is, the reference object 21a is used as a measurement reference in the Z-axis direction and around the X- and Y-axes, while the reference object 21b is used as a measurement reference in the X- and Y-axis directions and around the Z-axis. This makes it possible to provide measurement references free from any position dependent forces in the six axis-directions.

Measuring the reference object 21a using non-contact measuring devices 12z1, 12z2, and 12z3 makes it possible to measure a displacement of the surface plate 2 relative to the reference object 21a in the Z-axis direction and their relative angles around the X- and Y-axes. The reference object 21b is measured using non-contact measuring devices 12x1, 12x2, and 12y1 as well. This makes it possible to measure a displacement of the surface plate 2 relative to the reference object 21b in the X- and Y-axis directions and their relative angle around the Z-axis.

Feedback-controlling the position of the surface plate 2 based on the measured relative displacement and relative angle allows it to be free from the influence of any displacement due to vibration of the floor. The velocity of the surface plate 2 may be feedback-controlled with respect to the reference object 21.

As described above, also according to the fifth embodiment, it is possible to provide an anti-vibration apparatus excellent in low-frequency component removal performance, which is free from any natural frequency in principle.

### Sixth Embodiment

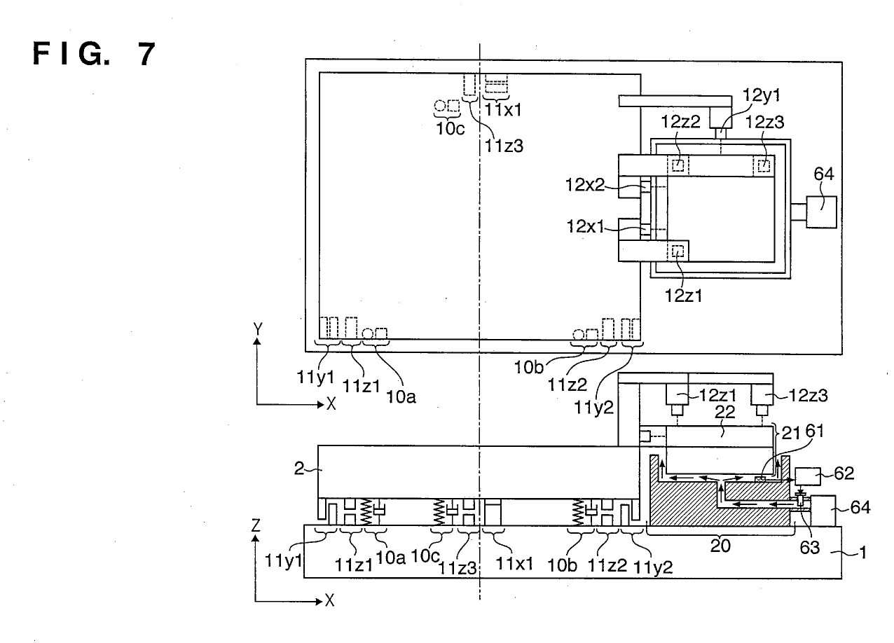

In the sixth embodiment shown in FIG. 7, the gas pressure is kept constant to apply, to a reference object 21, a force that balances gravitational force acting on it. This makes it possible to support the reference object 21 by a constant position independent force.

An actuator 20 for supporting the reference object by the gas pressure comprises a pressure sensor 61 for measuring the gas pressure, a controller 62 for adjusting the degree of opening of a servo valve 63 based on the measurement information obtained by the pressure sensor 61, and a pressure source 64 for supplying a gas. Adjusting the degree of opening of the servo valve 63 based on the measurement information obtained by the pressure sensor 61 makes it possible to supply, to the reference object 21, a gas at a constant pressure that balances its gravitational force.

In addition, measuring the position of the reference object 21 using a non-contact measuring device 12 makes it possible to calculate a displacement of a surface plate 2 relative to the reference object 21 supported by a constant force and their relative angle. Feedback-controlling the position of the surface plate 2 with respect to the reference object 21 based on the measured relative displacement and relative angle allows it to be free from the influence of any displacement due to vibration of the floor. The velocity of the surface plate 2 may be feedback-controlled with respect to the reference object 21.

Also according to the sixth embodiment, it is possible to provide an anti-vibration apparatus excellent in low-frequency component removal performance, which is free from any natural frequency in principle.

### Seventh Embodiment

In the seventh embodiment, a Lorentz's force actuator 23 includes a velocity feedback control system for suppressing a change in the velocity of a reference object 21 if it occurs. The velocity feedback control system for the reference object 21 will be explained.

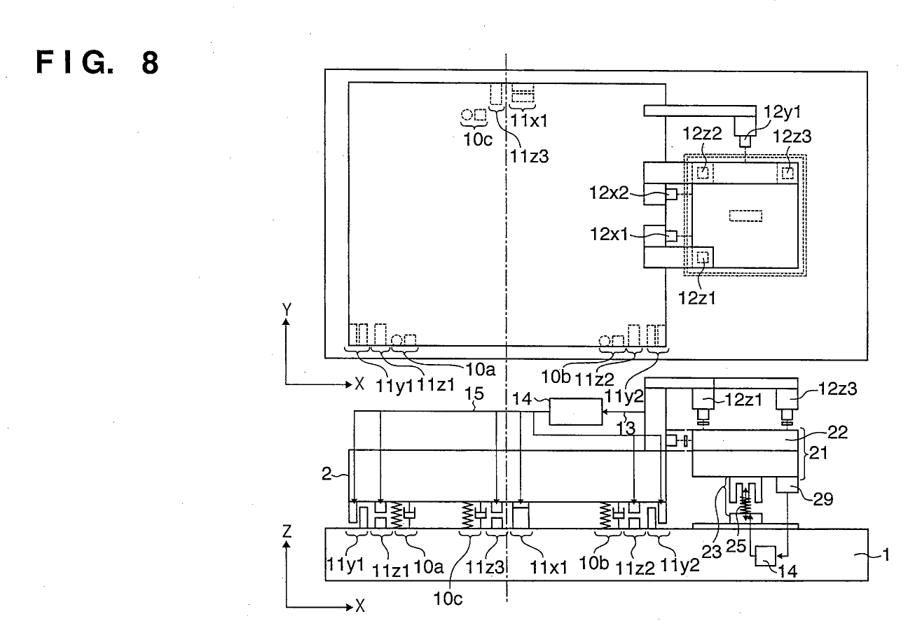

As shown in FIG. 8, a non-contact measuring device 29 (second measuring device) for measuring a change in the velocity of the reference object 21 is provided. A compensator 14 calculates an output to the Lorentz's force actuator 23 based on the measurement result obtained by the non-contact measuring device 29. As described above, if a change in the velocity of the reference object 21 occurs, the Lorentz's force actuator 23 generates a force to decrease it to be able to increase the stability of the velocity of the reference object 21.

In addition, measuring the position of the reference object 21 using a non-contact measuring device 12 makes it possible to calculate a displacement of a surface plate 2 relative to the reference object 21 with a better stability of velocity and their relative angle. Feedback-controlling the position of the surface plate 2 with respect to the reference object 21 based on the measured relative displacement and relative angle allows it to be less susceptible to the influence of any velocity due to vibration of the floor. This makes it possible to provide an anti-vibration apparatus that is excellent in stability against velocity.

### Eighth Embodiment

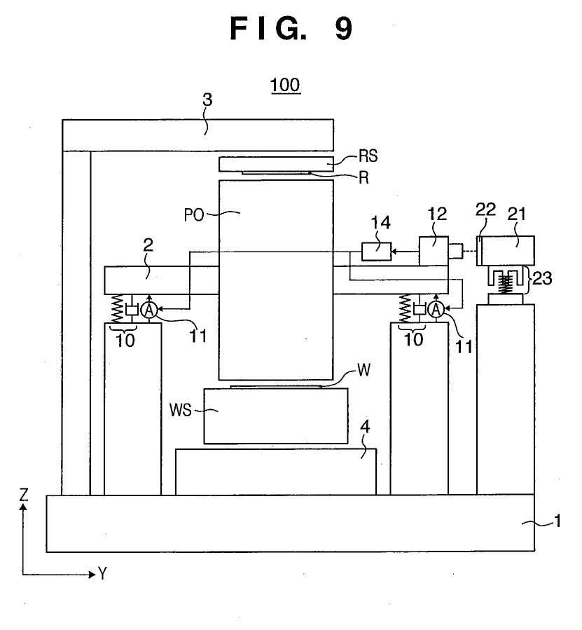

The eighth embodiment exemplifies a case wherein an anti-vibration apparatus according to the present invention is applied to a lens barrel supporting member of an exposure apparatus, as shown in FIG. 9. In this embodiment, a target object is the lens barrel supporting member. An exposure apparatus 100 is a projection exposure apparatus which executes exposure (pattern transfer) for a substrate by the step & scan scheme. The exposure apparatus 100 comprises a projection optical system PO for vertically projecting exposure light from a reticle R as an original onto a wafer W as a substrate. This exposure light contains pattern information formed on the reticle R.

In the following description, the direction in which the projection optical system PO projects the exposure light onto the wafer W is the optical axis direction of the projection optical system PO. This optical axis direction is the Z-axis direction. An in-plane direction perpendicular to the Z-axis direction within the sheet surface of FIG. 9 is the Y-axis direction. A direction perpendicular to the sheet surface is the X-axis direction.

The exposure apparatus 100 scans the reticle R and wafer W relative to the projection optical system PO linearly (in the Y-axis direction here) while projecting a partial device pattern drawn on the reticle R onto the wafer W via the projection optical system PO. With this operation, the entire device pattern of the reticle R is transferred onto a plurality of shot regions on the wafer W by the step & scan scheme.

A surface plate 2 supports the projection optical system PO. A floor 1 supports the surface plate 2 via passive dampers 10. Actuators 11 are interposed between the surface plate 2 and the floor 1. The actuator 11 uses a linear motor here.

The floor supports a reference object 21 via a Lorentz's force actuator 23. Supplying a constant current to the Lorentz's force actuator 23 allows it to output a constant force. The constant force output from the Lorentz's force actuator 23 is fully balanced gravitational force acting on the reference object 21. With this operation, the reference object 21 completely floats in the air and hence becomes free from the influence of any displacement due to floor vibration.

Measuring the reference object 21 using a non-contact measuring device 12 makes it possible to measure a displacement of the surface plate 2 relative to the reference object 21 supported by a constant force.

A compensator 14 converts measurement information 13 obtained by the non-contact measuring device 12 into a command value to be input to the actuator 11. The compensator 14 includes, for example, a decoupled matrix, PID compensator, and output distribution matrix.

As described above, it is possible to control to position the surface plate 2 with respect to the reference object 21 in the six axis-directions. Since the reference object 21 completely floats in the air and hence becomes free from the influence of any displacement due to vibration of the floor 1, the surface plate 2 the position of which is feedback-controlled with respect to the reference object 21 also becomes free from the influence of any displacement due to vibration of the floor 1.

As the reference object 21 receives a force that balances its gravitational force from the Lorentz's force actuator 23 and hence completely floats in the air, it is displaced in a direction opposite to that of rotation of the earth upon receiving a Coriolis force. The reference object 21 is likely to be displaced upon receiving a force due to some kind of external factor, in addition to the Coriolis force. It is therefore necessary to correct the position of the reference object 21 periodically or occasionally. The exposure apparatus 100 must correct the position of the reference object 21 by the step & scan scheme while the pattern on the reticle R is not transferred onto the wafer W.

### Embodiment of Device Manufacture

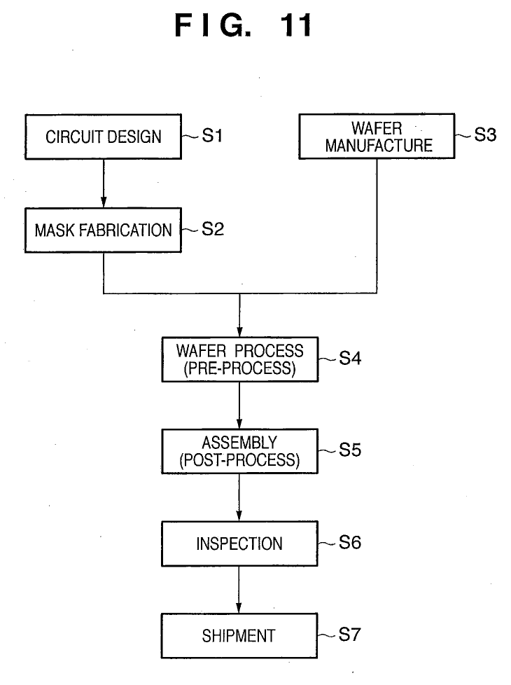

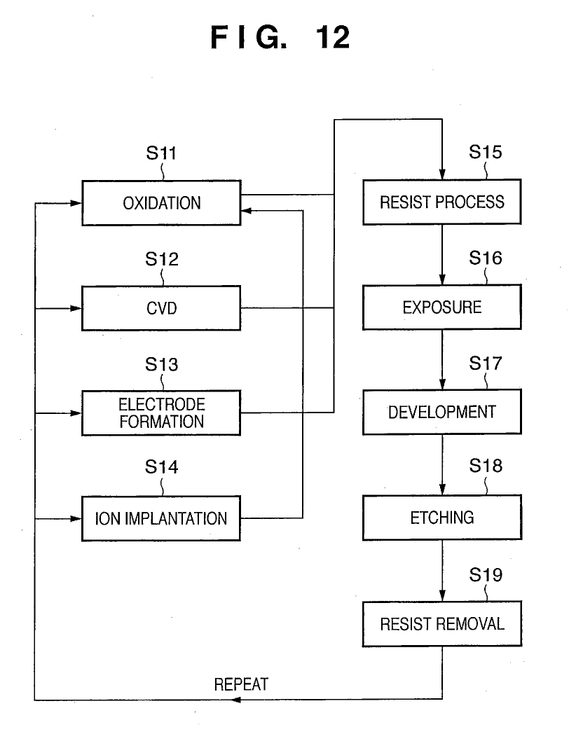

An embodiment of a device manufacturing method using the above-described exposure apparatus will be explained next with reference to FIGS. 11 and 12. FIG. 11 is a flowchart for explaining the manufacture of a device (for example, a semiconductor chip such as an IC or LSI, an LCD, or a CCD). A semiconductor chip manufacturing method will be exemplified here.

In step S1 (circuit design), the circuit of a semiconductor device is designed. In step S2 (mask fabrication), a mask is fabricated based on the designed circuit pattern. In step S3 (wafer manufacture), a wafer (substrate) is manufactured using a material such as silicon. In step S4 (wafer process) called a pre-process, the above-described exposure apparatus forms an actual circuit on the wafer by lithography using the mask and wafer. In step S5 (assembly) called a post-process, a semiconductor chip is formed using the wafer manufactured in step S4. This step includes an assembly step (dicing and bonding) and packaging step (chip encapsulation). In step S6 (inspection), the semiconductor device manufactured in step S5 undergoes inspections such as an operation confirmation test and durability test. After these steps, the semiconductor device is completed and shipped in step S7.

FIG. 12 is a flowchart illustrating details of the wafer process in step S4. In step S11 (oxidation), the wafer surface is oxidized. In step S12 (CVD), an insulating film is formed on the wafer surface. In step S13 (electrode formation), an electrode is formed on the wafer by vapor deposition. In step S14 (ion implantation), ions are implanted in the wafer. In step S15 (resist process), a photosensitive agent is applied to the wafer. In step S16 (exposure), the exposure apparatus transfers the circuit pattern of the mask onto the wafer by exposure. In step S17 (development), the exposed wafer is developed. In step S18 (etching), portions other than the developed resist image are etched. In step S19 (resist removal), any unnecessary resist remaining after etching is removed. These steps are repeated to form multiple circuit patterns on the wafer.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-249957, filed Sep. 14, 2006, which is hereby incorporated by reference herein in its entirety.

What is claimed is:

1. An anti-vibration apparatus comprising:
a target object;
a reference object;
a measuring device which measures a position of the target object relative to the reference object;
a driving mechanism to drive the target object based on the measurement result obtained by the measuring device;
a Lorentz's force actuator which supports the reference object; and
a power supply device which supplies a constant current to the Lorentz's force actuator.

2. The apparatus according to claim 1, further comprising:
a second measuring device which measures a change in velocity of the reference object,
wherein the Lorentz's force actuator supports the reference object based on the measurement result obtained by the second measuring device.

3. An anti-vibration apparatus comprising:
a target object;
a reference object;
a measuring device which measures a position of the target object relative to the reference object;
a driving mechanism to drive the target object based on the measurement result obtained by the measuring device; and
an actuator which supports the reference object by a pressure of a gas,
wherein the actuator is controlled to support the reference object by a constant pressure.

4. The apparatus according to claim 3, wherein the actuator includes a pressure sensor which measures a pressure of a gas, a servo valve which controls a flow rate of the gas, and a controller which calculates, based on the measurement result obtained by the pressure sensor, a command value to be input to the servo valve.

5. The apparatus according to claim 1, wherein one of an air guide and an electromagnetic guide constrains at least one axis of the reference object.

6. The apparatus according to claim 1, further comprising:
a third measuring device which measures a position of the reference object,
wherein the position of the reference object is corrected based on the measurement result obtained by the third measuring device.

7. An exposure apparatus which includes an original stage, a substrate stage, and a lens barrel of a projection optical system, comprising:
an anti-vibration apparatus as recited in claim 1,
wherein the anti-vibration apparatus is configured to cause the target object to support one of the original stage, the substrate stage, and the lens barrel of the projection optical system.

8. A device manufacturing method comprising the steps of:
exposing a substrate using an exposure apparatus as recited in claim 7; and
developing the substrate.

9. The apparatus according to claim 3, wherein one of an air guide and an electromagnetic guide constrains at least one axis of the reference object.

10. The apparatus according to claim 3, further comprising:
a third measuring device which measures a position of the reference object,
wherein the position of the reference object is corrected based on the measurement result obtained by the third measuring device.

11. An exposure apparatus which includes an original stage, a substrate stage, and a lens barrel of a projection optical system, comprising:
an anti-vibration apparatus as recited in claim 3,
wherein the anti-vibration apparatus is configured to cause the target object to support one of the original stage, the substrate stage, and the lens barrel of the projection optical system.

12. A device manufacturing method comprising the steps of:
exposing a substrate using an exposure apparatus as recited in claim 11; and
developing the substrate.
